(19) United States
(12) Patent Application Publication
(10) Pub. No.: US 2004/0140594 A1
(43) Pub. Date: Jul. 22, 2004

(54) Method of making a plastic elbow fitting

(76) Inventor: Huang Liu, Wu-Ryh Country (TW)

Correspondence Address: David E. Dougherty, Dennison, Schultz, Dougherty & MacDonald, 1727 King Street, Suite 105, Alexandria, VA, 22314, US

(21) Appl. No.: 10/347,878

(22) Filed: Jan. 22, 2003

(51) Int. Cl. B29D 23/00; B29C 51/10

(52) U.S. Cl. 264/573

(57) ABSTRACT

A method of manufacturing a plastic elbow fitting for a pipe comprises heating thermoplastic materials to form a tube, closing left and right molds, feeding the tube into the molds, inserting a metal wire or rod into the tube as the tube travels at bent portions of the molds for guiding the tube beyond the other ends of the molds, closing gates of the molds for breaking the tube into sections, injecting hot air into the tube for blowing the tube outward to fill the molds, and ejecting the formed elbow fitting from the molds after cooling. This is a safe, high performance process.

### FIELD OF THE INVENTION The present invention relates to fitting manufacturing processes and more particularly to a method of making a plastic elbow fitting with improved characteristics.

### BACKGROUND OF THE INVENTION

A conventional manufacturing process of making a plastic elbow fitting 10 having two outer peripheral grooves 20, 22 proximate ends (see FIG. 1) comprises feeding a tube formed of melted thermoplastic pellets (or powder) into two molds from top, inserting a hand into the tube as the tube travels at bent portions of the molds, guiding the tube beyond the other ends of the molds, closing gates of the molds for breaking the tube into sections, injecting hot air into the tube to blow the tube outward to fill the molds, and ejecting a formed elbow fitting from the molds after cooling.

However, the prior art suffered from a disadvantage. For example, the step of inserting a hand into the tube is dangerous. Further, the manual operation is not consistent, resulting in a low yield. Hence, a need for improvement exists.

### SUMMARY OF THE INVENTION

It is therefore an object of the present invention to provide a high performance, safe method of making a plastic elbow fitting.

To achieve the above and other objects, the present invention provides a method of manufacturing a plastic elbow fitting for a pipe comprising heating thermoplastic materials to form a tube; closing left and right molds; feeding the tube into the molds; inserting a metal wire or rod into the tube as the tube travels at bent portions of the molds for guiding the tube beyond the other ends of the molds; closing gates of the molds for breaking the tube into sections; injecting hot air into the tube; blowing the tube outward to fill the molds; cooling the molds; and ejecting the formed elbow fitting from the molds.

The above and other objects, features and advantages of the present invention will become apparent from the following detailed description taken with the accompanying drawings.

### BRIEF DESCRIPTION OF THE DRAWINGS

FIG. 1 is a perspective view of a plastic elbow fitting manufactured according to a conventional process;

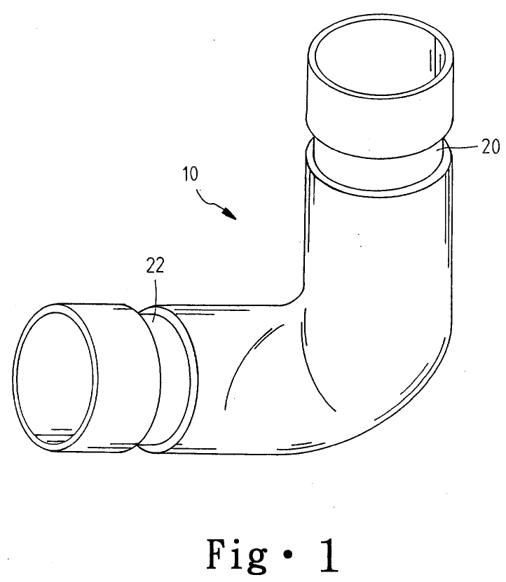

FIG. 2 is a flow chart illustrating a manufacturing process according to the invention;

FIG. 3 is a side view of one of two molds for manufacturing a plastic elbow fitting according to the invention; and

FIG. 4 is a side view showing a complete mold according to the invention.

### DETAILED DESCRIPTION OF THE PREFERRED EMBODIMENTS

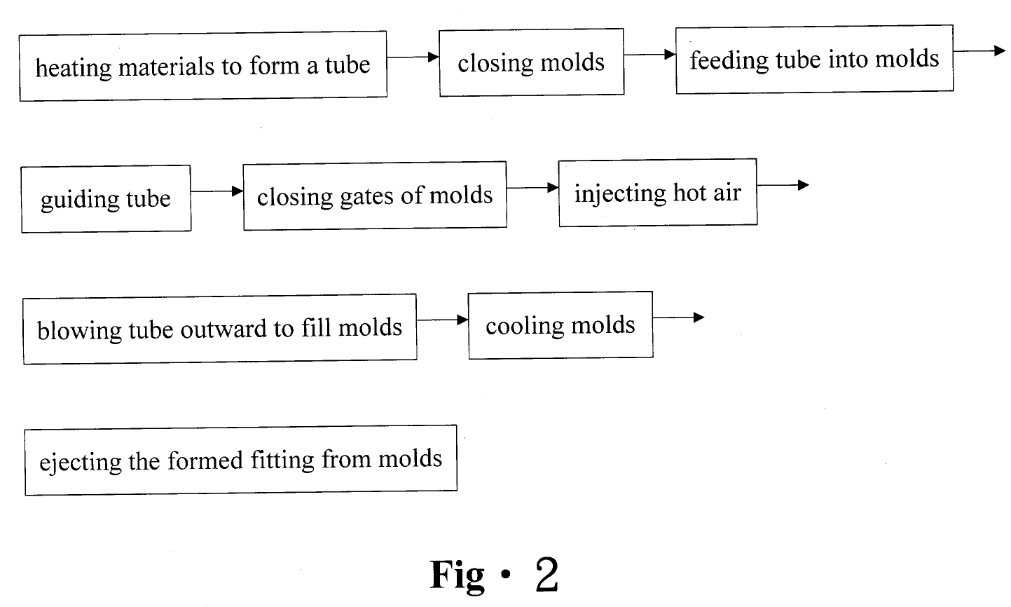

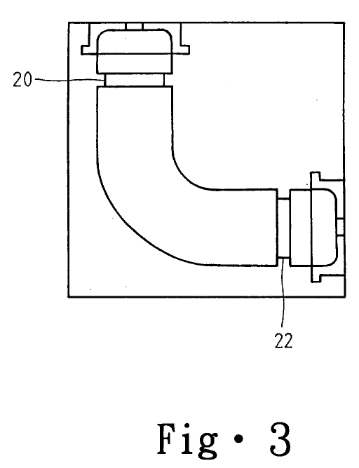

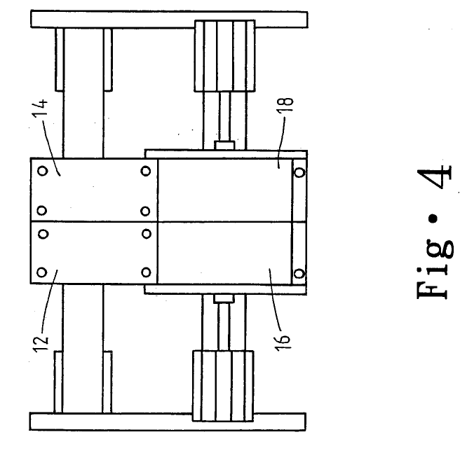

Referring to FIG. 2 in conjunction with FIGS. 3 and 4, there is shown a flow chart illustrating a process of manufacturing a plastic elbow fitting having two outer peripheral grooves 20, 22 proximate ends according to the invention. The process comprises heating thermoplastic pellets (or powder) to form a tube, closing left and right molds 12, 14 to form a complete mold, feeding the tube into the mold from top, inserting a tool such as metal wire or rod into the tube as the tube travels at bent portions of the molds for guiding the tube beyond the other ends of the molds, closing gates of the molds 12, 14 for breaking the tube into sections, injecting hot air into the tube; blowing the tube outward to fill the molds 12, 14, cooling the molds 12, 14, and ejecting a formed elbow fitting from the molds 12, 14.

In brief, the invention does not require a manual operation in the step of guiding the tube beyond the other ends of the molds. Hence, it is safe and consistent, resulting in a high yield.

While the invention has been described by means of specific embodiments, numerous modifications and variations could be made thereto by those skilled in the art without departing from the scope and spirit of the invention set forth in the claims.

What is claimed is:

1. A method of manufacturing a plastic elbow fitting for a pipe comprising:
heating thermoplastic materials to form a tube;
closing left and right molds;
feeding the tube into the molds;
inserting a metal wire or rod into the tube as the tube travels at bent portions of the molds for guiding the tube beyond the other ends of the molds;
closing gates of the molds for breaking the tube into sections;
injecting hot air into the tube;
blowing the tube outward to fill the molds;
cooling the molds; and
ejecting the formed elbow fitting from the molds.
